(19) United States
(12) Patent Application Publication
(10) Pub. No.: US 2026/0356230 A1
(43) Pub. Date: Nov. 12, 2026

(54) SYSTEM AND METHOD FOR OPTIMIZING CHARGING AND DISCHARGING FOR INDIVIDUAL VEHICLES

(71) Applicant: NISSAN NORTH AMERICA, INC., Franklin, TN (US)

(72) Inventors: Aaron KANDEL, San Francisco, CA (US); Hironobu KIUCHI, Sunnyvale, CA (US); Geoffrey PETTET, Oakland, CA (US)

(21) Appl. No.: 19/205,978

(22) Filed: May 12, 2025

(51) Int. Cl. B60L 53/64; B60L 53/62; B60L 55/00; G06Q 50/06

(52) U.S. Cl. CPC B60L 53/64; B60L 53/62; B60L 55/00; G06Q 50/06

(57) ABSTRACT

A system for managing charging and discharging of a vehicle interfacing with a demand source and a power grid is provided. The system includes a charging station and a controller. The charging station is configured to at least one of supply power to and draw power from the vehicle. The controller is configured to control at least one of charging and discharging of the vehicle based on at least one of: a first user input and a second user input. The first user input is a first value representing prioritization of ensuring a sufficient state of charge for the battery at a given time over maximizing revenue generated by discharging the battery. The second user input is a second value representing prioritization of ensuring a battery health for the battery over maximizing revenue generated by discharging the battery.

### BACKGROUND

### Field of the Invention

The present disclosure generally relates to a system for managing the charging and discharging of a vehicle interfacing with a demand source and a power grid, and a process for managing the charging and discharging of the vehicle using the system.

### Background Information

Vehicle grid integration systems (“VGIs”) are desirable because they allow optimal usage of power on the grid by managing the charging and discharging of electric vehicles (“EVs”) to decrease the peak power demand and save on power costs. In particular, these VGIs manage the scheduling of charging and discharging of various vehicles on the grid in order to use the power from the vehicles to decrease the peak power demand and, thus, the energy costs, of a system on the grid.

VGIs include a demand source, such as a residential or commercial building, an industrial facility, a transportation system, an agricultural system, or another power demand source connected to the grid, and a plurality of EVs interfacing with the demand source. By controlling the charging and discharging of the EVs at specified times, the VGI can draw power from the demand source to charge the vehicles and discharge the vehicles to provide power to the demand source to reduce the peak power demand of the demand source and thereby save energy costs.

Furthermore, vehicles connected to a VGI can generate revenue or income based on how much power they discharge to the grid, and the timing of such discharging. In particular, it has been known to optimize the revenue generated by individual vehicles connected to VGIs, while maintaining a desired battery capacity and vehicle range. In such conventional systems, income generation optimization is based on battery life modeling, as well as personal usage and environmental factors. In addition, the desired battery capacity and vehicle range are all input by a user, whereas the battery life for a given capacity retention is estimated, or vice versa, based on test data.

However, there are some drawbacks with conventional revenue optimization for vehicles in a VGI. In particular, conventional VGI revenue optimization fails to consider ensuring a sufficient state of charge for a user at any given time, thus allowing the user more flexibility in how the vehicle is used. Such systems therefore fail to account for uncertain user behavior, such as uncertainty in when the user will depart from the VGI and unplug from the charging station. For example, since the minimum state of charge is not necessarily the same as the required departure state of charge, if the user departs from the VGI at an earlier than expected time or at a different time than the user inputs or estimates, the minimum state of charge of the vehicle battery may not be sufficient. Therefore, further improvement is needed to develop a system of better managing the charging and discharging of an individual EV to optimize revenue generation while also ensuring not just sufficient battery health but also sufficient user flexibility, i.e., accessibility, in how the vehicle is used.

### SUMMARY

It has been discovered that the VGI revenue of an individual EV can be optimized while also ensuring both a desired battery health and a desired accessibility by managing the charging and discharging of the individual EV based on: a first user input representing prioritization of accessibility over maximizing the VGI revenue, and a second user input representing prioritization of battery health over maximizing the VGI revenue. By managing the charging and discharging of an individual EV based on the first user input representing prioritization of accessibility over maximizing VGI revenue, the system is able to account for uncertain user behavior such as departing the VGI earlier than expected by allowing the user to prioritize user flexibility or accessibility to a larger degree. Furthermore, by allowing the user to select the prioritization level or value for both accessibility and battery health, the system can allow the user more control in ensuring that the VGI revenue is not maximized at the expense of battery health or accessibility.

In view of the state of the known technology, one aspect of the present disclosure is to provide a system for managing charging and discharging of a vehicle interfacing with a demand source and a power grid. The system includes a charging station and a controller. The charging station is configured to at least one of: supply power to and draw power from the vehicle at specified times. The controller is configured to control at least one of charging and discharging of the vehicle by the charging station based on at least one of: a first user input and a second user input. The first user input is a first value representing prioritization of ensuring a sufficient state of charge for the battery at a given time over maximizing revenue generated by discharging the battery to generate power for the power grid. The second user input is a second value representing prioritization of ensuring a battery health for the battery over maximizing revenue generated by discharging the battery to generate power for the power grid. By using such a system to control the charging and discharging of an individual vehicle, VGI revenue for the vehicle can be optimized while still ensuring both adequate battery health and user accessibility.

Another aspect of the present disclosure is to provide a method of managing charging and discharging of a vehicle interfacing with a demand source and a power grid. The method includes providing a controller configured to control charging and discharging of a battery of the vehicle at specified times, and controlling the charging and discharging of the battery using the controller based on at least one of: a first user input and a second user input. The first user input is a first value representing prioritization of ensuring a sufficient state of charge for the battery at a given time over maximizing revenue generated by discharging the battery to generate power for the power grid. The second user input is a second value representing prioritization of ensuring a battery health for the battery over maximizing revenue generated by discharging the battery to generate power for the power grid.

By managing the charging and discharging of an individual EV based on the first user input representing prioritization of accessibility over maximizing VGI revenue, the system is able to account for uncertain user behavior or changes in user behavior. For example, if the user departs the VGI earlier than expected or changes behavior such as arrival or departure time from the VGI, the system can still ensure that the vehicle has a sufficient state of charge when it departs the VGI by increasing the value representing prioritization of accessibility over maximizing VGI revenue. Furthermore, by allowing the user to select the prioritization level or value for both accessibility and battery health, the system can allow the user more control in ensuring that the VGI revenue is not maximized at the expense of either battery health or flexibility in being able to use the vehicle. In addition, when there are a plurality of vehicles in the VGI, the VGI can optimize revenue generation for each of the vehicles based on the individual user inputs regarding accessibility and battery health, and the overall system needs.

### BRIEF DESCRIPTION OF THE DRAWINGS

Referring now to the attached drawings which form a part of this original disclosure:

FIG. 1 is a perspective view of a system for charging and discharging a plurality of vehicles according to a first embodiment;

FIG. 2 is a chart showing a charge profile over time for a vehicle in a vehicle grid integration system according to a second embodiment;

FIG. 3a is a first user terminal showing a first user input for accessibility and a second user input for battery barrier according to a third embodiment;

FIG. 3b is a second user terminal showing a first user input for accessibility and a second user input for battery barrier according to the third embodiment;

FIG. 3c is a chart showing charge profiles over time for a vehicle in a vehicle grid integration system based on the first and second user inputs from the first and second user terminals according to the third embodiment;

FIG. 4a is a user terminal showing a first user input for accessibility and a second user input for battery barrier according to a fourth embodiment;

FIG. 4b is a chart showing charge profiles over time for a vehicle in a vehicle grid integration system based on the first and second user inputs and default values for accessibility and battery barrier according to the fourth embodiment;

FIG. 5 is an illustrated flow chart showing a process of managing the charging and discharging of a vehicle by generating a charge profile for the vehicle according to a fifth embodiment;

FIG. 6 is an illustrated flow chart showing a process of estimating VGI revenue for a vehicle in a vehicle grid integration system according to a sixth embodiment; and

FIG. 7 is a Pareto front chart showing the tradeoff between charging cost and charging insufficiency for a vehicle in a vehicle grid integration system according to a seventh embodiment.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

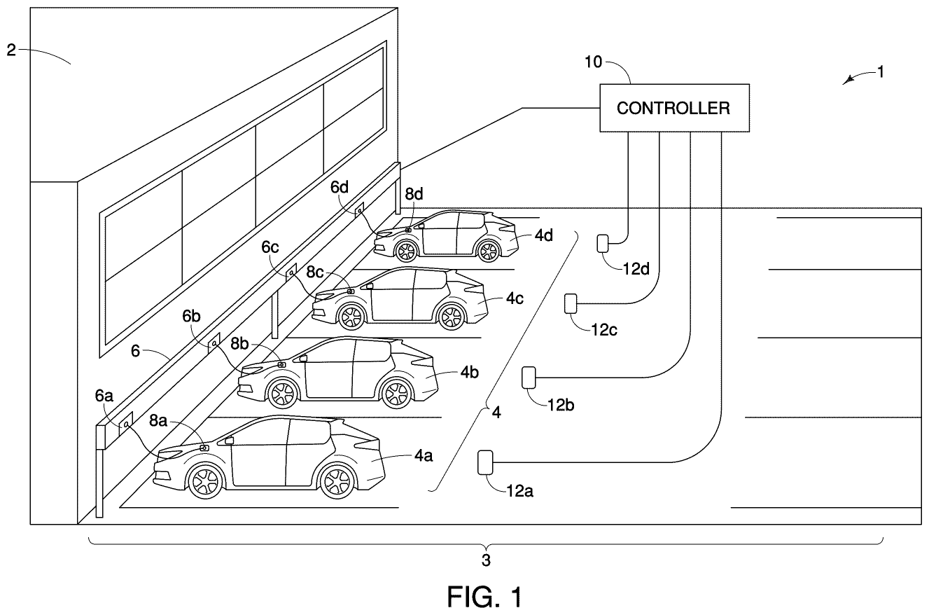

Referring initially to FIG. 1, a system 1 for charging and discharging a plurality of vehicles is illustrated according to a first embodiment. The system 1 includes a building 2 as a power demand source, a parking lot 3, a plurality of vehicles 4, a charging station 6 that includes a plurality of charging and discharging ports 6a-6d, a plurality of charging and discharging ports 8a-8d, a controller 10 and a plurality of external devices 12a-12d.

The building 2 can be any suitable building connected to a power grid. For example, the building 2 can be an office building or a residential building. The building 2 is configured to draw power from the power grid to meet its energy demands. For example, the building 2 can be configured to draw power from the grid to run the electrical system(s), the heating system(s) and the air conditioner(s) in the building 2. The building 2 is also configured to draw power from the power grid to supply power to the charging station 6.

The system 1 also includes a parking lot 3 in which the plurality of vehicles 4 are parked. As shown in FIG. 1, the plurality of vehicles 4 includes vehicles 4a, 4b, 4c and 4d. Each of the vehicles 4a-4d is an electric vehicle that includes a bidirectional charging port 8a-8d. The charging ports 8a-8d are each configured to allow charging and discharging of the electric vehicles 4a-4d.

As shown in FIG. 1, the charging station 6 is attached to the building 2. However, it should be understood that the charging station 6 can be located in any suitable location, such as adjacent to the building 2 or within a predetermined distance from the building 2, as long as the charging station 6 is configured to draw power from and supply power to the building 2. The charging station 6 includes a plurality of bidirectional charging ports 6a, 6b, 6c and 6d that are each configured to supply power to and draw power from a vehicle connected thereto. In FIG. 1, only one charging station 6 is shown. However, it should be understood that any suitable number of charging stations can be provided in the system 1. Alternatively, the charging ports 6a-6d may be unidirectional charging ports that are only configured to supply power to a vehicle connected thereto. The charging station 6 is controlled by the controller 10.

The controller 10 is any suitable electronic controller 10 configured to control the charging station 6 to charge and discharge electric vehicles connected to the bidirectional charging ports 6a-6d. For example, the controller 10 includes one or more processors that execute predetermined control programs to control the charging and discharging of electrical power via the charging ports 6a-6d. However, it should be understood that the controller 10 can alternatively be configured to control the charging station 6 to only charge electric vehicles connected to the charging ports 6a-6d if the charging ports are unidirectional charging ports. The processors of the electronic controller 10 include, for example, a central processing unit (“CPU”) or a micro-processing unit (“MPU”).

The processors of the electronic controller 10 can be located at separate positions. For example, some of the processors can be provided in the building 2, and the other processors can be provided in a remote server connected to the internet. In a case where the processors are located at separate positions, the processors are connected to one another via a wireless communication device in a manner allowing for communication. The electronic controller 10 can include one or more microcomputers. Thus, the term “electronic controller” as used herein refers to hardware that executes a software program, and does not include a human.

The electronic controller 10 is in communication with the charging station 6 via wired or wireless communication. For example, the electronic controller 10 can be located in or within a predetermined distance of the building 2 and can include a communication unit in wired communication with the charging station 6. The electronic controller 10 is configured to send commands to the charging station 6 to control the charging and discharging of vehicles connected to the charging ports 6a-6d of the charging station 6.

The electronic controller 10 is also in communication with the vehicles 4a-4d via the charging station 6 (i.e., the charging ports 6a-6d) or via the internet. The electronic controller 10 is configured to receive information regarding vehicle conditions from each of the vehicles 4a-4d. For example, the electronic controller 10 is configured to receive information regarding the battery, such as the battery temperature or the state of charge, for each of the vehicles 4a-4d. The electronic controller 10 is also configured to receive historical information regarding the usage of the vehicles 4a-4d, such as past arrival and departure times at the building 2 for each of the vehicles 4a-4d or past arrival and departure times from a home or residential building for each of the vehicles 4a-4d.

The electronic controller 10 is also in communication with external devices 12a, 12b, 12c and 12d, for example via the internet. The external devices 12a-12d correspond to vehicles 4a-4d, respectively, and can be any suitable external devices that allow a user to select or input values that represent prioritization of variables related to charging or discharging the respective vehicle versus maximizing revenue generated by discharging the vehicle. The external devices 12a-12d can be any combination of cellular phones, laptop or desktop computers, or any other personal electronic devices with a graphical user interface (“GUI”) that allows a user to select values based on information that is displayed on the GUI. The external devices 12a-12d are preferably cellular phones. The external devices 12a-12d can be located inside the respective vehicles 4a-4d and/or remotely operated by a user of the vehicles 4a-4d.

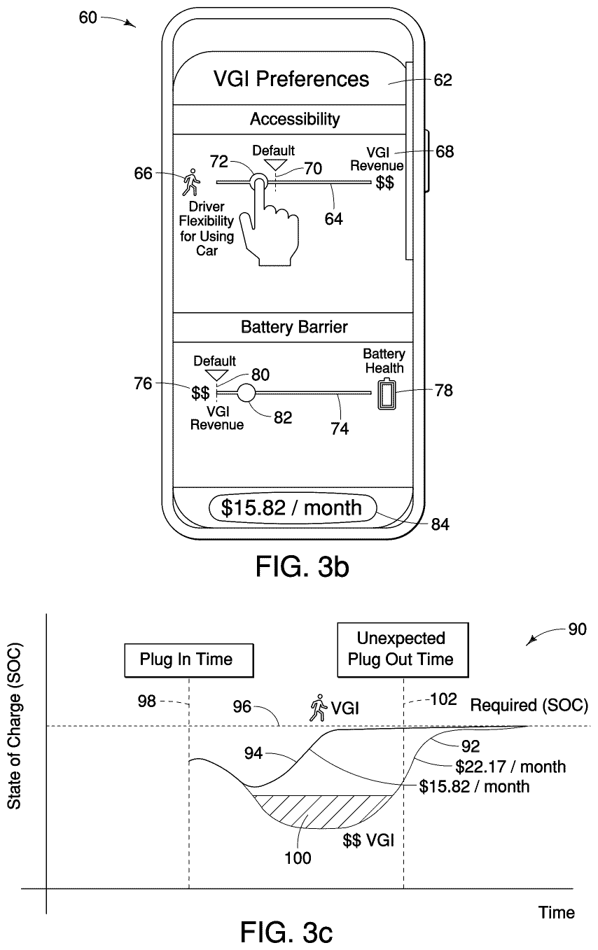

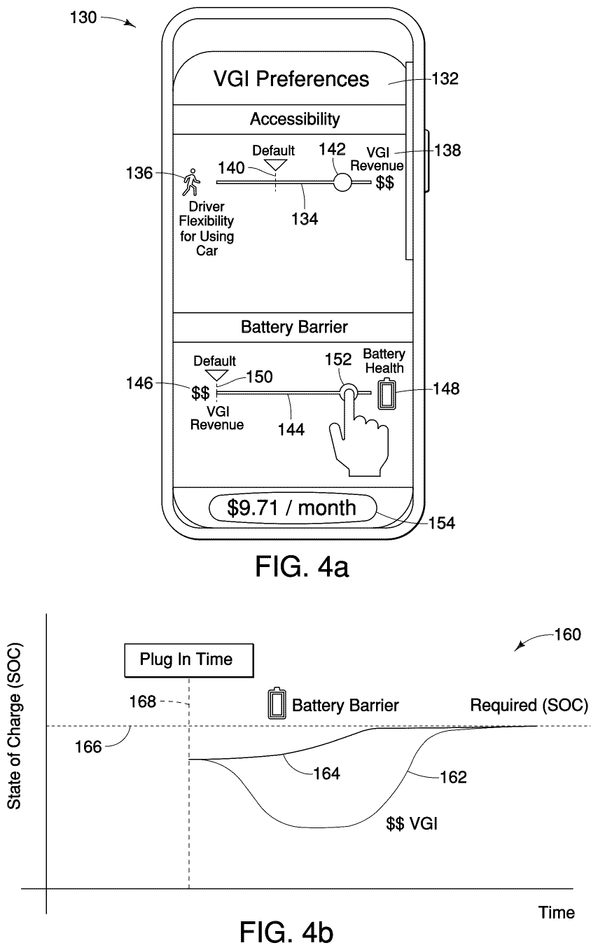

As will be explained in detail below with respect to FIGS. 3a-3b and 4a, the external devices 12a-12d each correspond to a respective vehicle 4a-4b and are configured to allow a user to enter a first user input value, representing prioritization of ensuring a sufficient state of charge for the battery at a given time over maximizing revenue generated by discharging the battery to generate power for the power grid, and a second user input value, representing prioritization of ensuring a battery health for the battery over maximizing revenue generated by discharging the battery to generate power for the power grid. The GUIs of the external devices 12a-12d are also configured to display default values for the first and second user inputs, and the user can then choose whether to accept the default value or increase or decrease the value with respect to the default value.

The electronic controller 10 is configured to receive the first and second user input values from the external devices 12a-12d. The electronic controller 10 is then configured to control the charging and discharging of the vehicles 4a-4d connected to the charging station 6 using power from the grid. In particular, the electronic controller 10 is configured to control the charging ports 6a-6d to supply power to and draw power from each of the vehicles 4a-4d at specified times. For example, the electronic controller 10 is configured to determine whether to charge or discharge power from the vehicles 4a-4d at predetermined times based on a power demand of the building 2, a state of charge of each of the vehicles 4a-4d, a predicted departure time from the building 2, a predicted health effect on the batteries of the vehicles 4a-4d, and the first and second user inputs received from external devices 12a-12d.

The power demand of the building 2 at a given time can either be directly detected by at least one sensor in the building 2, or the power demand can be predicted by a model trained using machine learning. For example, in order to determine the predicted power demand using a trained model, the controller 10 is configured to access historical data from the building 2, such as historical power usage patterns for the building 2.

The state of charge of each of the vehicles 4a-4d at a given time can be detected via one or more sensors located in each of the vehicles 4a-4d. The required state of charge for each of the vehicles 4a-4d at departure can be input by a user or predicted based on a model trained using machine learning. For example, the model can be trained based on historical data for each of the vehicles 4a-4d, such as the distance from the building 2 to the user's residence or the vehicle usage, historical data for the building and/or location, and the required state of charge for each of the vehicles 4a-4d can be predicted based on the information in the model.

The estimated departure time for each of the vehicles 4a-4d can be predicted by a model, rather than input by a user. For example, the departure times for each vehicle are not input by a user and instead a probability distribution of departure times can be predicted by a model trained using machine learning. The model can be trained to predict departure time probability distributions based on historical information for the vehicle and/or the user of the vehicle, as well as historical data for the demand source. Furthermore, the predicted departure time probability distributions can be updated over time, either at predetermined times or intervals, or as new vehicles arrive at the building 2 or the charging station 6.

The battery health effects for each of the vehicles 4a-4d can also be predicted by a model, rather than input by a user. For example, the battery health effects of charging or discharging for each of the vehicles 4a-4d can be predicted by a model trained using machine learning. The model can be trained to predict a future state of health of the battery based on historical information for the vehicle battery and/or the user of the vehicle, as well as historical data for the demand source. For example, any one of the accessibility setting, the maximum charge-discharge rate, the maximum cycles/hour, the maximum time at high/low state of charge per hour, the maximum time at which the battery is at a high temperature per hour, driving pattern data regarding the vehicle, and time lookahead can be input to the model. The model can output a future state of health at the time lookahead.

Any suitable method can be used to map VGI user settings to battery state of health, for example a VGI session can be mapped to similar regular charging sessions to determine how a certain level of VGI participation can map to long-term battery state of health. Furthermore, the predicted battery health effects can be updated over time, either at predetermined times or intervals, or as new vehicles arrive at the building 2 or the charging station 6.

The first user input is a value representing prioritization of ensuring a sufficient state of charge for the battery at a given time over maximizing revenue generated by discharging the vehicle battery to generate power for the power grid. The value can be any suitable number that indicates how much to prioritize ensuring a sufficient state of charge for the battery at any given time over maximizing revenue generated by discharging the vehicle battery to generate power for the grid. For example, the value can be a number from 0 to 1.0 indicating a tradeoff parameter value, between charge insufficiency and charging cost, for a Pareto front simulation calculated using historical data regarding the vehicles 4a-4d and/or the demand source 2.

The second user input is a value representing prioritization of ensuring a battery health for the battery over maximizing revenue generated by discharging the battery to generate power for the power grid. The value can be any suitable number that indicates how much to prioritize ensuring a sufficient battery health for the vehicle battery over maximizing revenue generated by discharging the vehicle battery to generate power for the grid. For example, the value can be a number from 0 to 1.0 indicating a tradeoff parameter value, between battery health and charging cost, for a Pareto front simulation calculated using historical data regarding the vehicles 4a-4d and/or the demand source 2.

The electronic controller 10 then determines whether to charge or discharge a battery of one of the vehicles 4a-4d at a given time based on the power demand of the building 2, the current state of charge of the vehicles 4a-4d, the predicted required state of charge for each of the vehicles 4a-4d at departure and the first and second user inputs received from external devices 12a-12d. The electronic controller 10 can also optionally divide the vehicles 4a-4d into charging and discharging groups. The determination of how much to charge or discharge power from each of the vehicles 4a-4d is based, at least in part, on the prioritization values for the first and second user inputs regarding accessibility and battery health. Based on the determination of whether to charge or discharge power from each of the vehicles 4a-4d at a specified time, and the determination of how much to charge or discharge, the electronic controller 10 is configured to send commands to the charging station 6, in particular the charging ports 6a-6d, to supply power to or draw power from each of the vehicles 4a-4d at the specified times. The controller 10 can determine the amount of charging and discharging for each vehicle by comparing the predicted revenue for each vehicle, calculating all cars' schedules simultaneously, ensuring each cars' battery barrier constraints are adhered to, and each car's accessibility is considered in the total cost function. For example, the higher the desired battery barrier and/or accessibility value is, the less flexible the charge schedule will be for that user.

In this embodiment, the charging station 6 is a bidirectional charging station, the charging ports 6a-6d are bidirectional charging ports, and the controller 10 is configured to control both the charging and discharging of vehicles. However, it should be understood that the features of this embodiment can also be applied to a unidirectional system in which the charging station 6 and the charging ports 6a-6d are unidirectional, and the controller 10 is configured to control only the charging of vehicles.

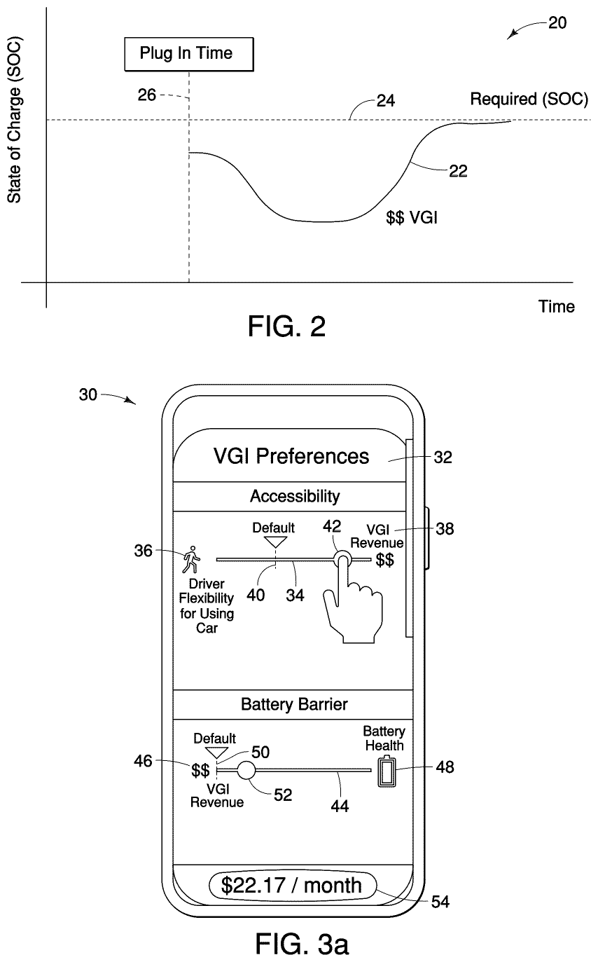

FIG. 2 shows a chart 20 of a state of charge or charge profile over time for a vehicle in a vehicle grid integration system according to a second embodiment. The VGI includes a building as a power demand source, the vehicle, a charging station and a controller. The building can be any suitable building connected to a power grid and configured to draw power from the power grid to meet its energy demands. For example, the building can be an office building or a residential building. Although the chart 20 applies to a VGI in which the power demand source is a building connected to the grid, it should be understood that the VGI can apply to any suitable power demand source connected to the grid, such as a transportation system or an agricultural system. The controller is configured to control the charging and discharging of the vehicle using the charging station. The VGI can be used to reduce the peak demand of the building using power discharged from the vehicle, as well as any other vehicles connected to the VGI.

The chart 20 shows the state of charge 22 for the vehicle over time from a plug in time to a departure time for the vehicle. The chart 20 also shows the required departure state of charge 24 for the vehicle. As shown in FIG. 2, the vehicle is initially discharged and is later charged to reach the required departure state of charge 24. By discharging the vehicle in this manner, revenue is generated for the vehicle ($$ VGI or VGI revenue) by discharging the battery to generate power for the power grid. As will be explained in further detail below, the charge profile or charging/discharging over time of the vehicle is based on first and second user inputs regarding prioritizing accessibility and battery health over maximizing VGI revenue. Thus, the VGI revenue is optimized by taking into account a user's desire to ensure a sufficient state of charge over a wide range of possible departure times, as well as the user's desire to ensure that battery health is not significantly deteriorated in an effort to maximize VGI revenue. These two factors are weighed against maximizing VGI revenue in order to determine the optimal VGI revenue for the individual vehicle and/or user.

FIG. 3a is a first user terminal 30 showing first and second user inputs for accessibility and battery barrier according to a third embodiment. In particular, the first user terminal 30 allows a user with a vehicle in a VGI to customize the VGI revenue generated by the vehicle to ensure the desired levels of accessibility and battery health.

As shown in FIG. 3a, the first user terminal 30 is a cellular phone that includes a GUI 32. However, it should be understood that the first user terminal 30 can be any suitable personal electronic device, such as a laptop or desktop computer, which allows a user to select values based on information displayed on the GUI. The user terminal 30 can be located inside a vehicle that is connected to a VGI and/or remotely operated by a user of the vehicle.

In particular, the GUI 32 displays VGI preferences including Accessibility and Battery Barrier to a user of the vehicle connected to the VGI. For the Accessibility preference, the GUI 32 displays a line 34 between two variables—driver flexibility for using the car 36 and VGI revenue $$ 38. The line 34 represents a scale allowing the user to choose the relative importance between the two variables 36 and 38. Variable 36 represents the user's flexibility in being able to use the vehicle in the VGI. For example, variable 36 represents the importance of ensuring that the vehicle has a sufficient state of charge at any given time such that if the vehicle departs the VGI at an earlier than expected time, the state of charge will be high enough that the user can still use the vehicle as desired.

Maximizing VGI revenue 38 necessarily means negatively affecting the state of charge for the vehicle battery at a given time, thereby reducing the user's flexibility in using the vehicle. As such, there is a tradeoff between variables 36 and 38. In other words, if variable 38 is weighed more heavily such that the user selects a value on line 34 that is closer to variable 38 than variable 36, maximizing VGI revenue will be prioritized higher than ensuring a sufficient state of charge for the vehicle. In contrast, if variable 36 is weighed more heavily, i.e., the user selects a value on line 34 that is closer to variable 36 than variable 38, ensuring a sufficient state of charge for the vehicle at a given time will be prioritized higher than maximizing VGI revenue generated by discharging the vehicle.

As shown in FIG. 3a, the GUI 32 displays a default value 40 for the Accessibility selection. The default value 40 is a value determined or predicted by a model trained using machine learning. For example, the model can be trained based on historical data for the user and/or vehicle, such as plug-in times for the vehicle at the VGI, arrival state of charge and departure state of charge for the vehicle and/or user.

The user can then decide whether to increase or decrease the Accessibility preference from the default value 40. The final user selection is shown in FIG. 3a as the first user input 42.

For the Battery Barrier preference, the GUI 32 displays a line 44 between two variables—VGI revenue 46 and battery health 48. The line 44 represents a scale allowing the user to choose the relative importance between the two variables 46 and 48. Variable 48 represents the importance of ensuring good battery health for the vehicle. For example, variable 48 represents the importance of ensuring that the vehicle is not charged or discharged in a way that negatively impacts battery health.

Maximizing VGI revenue 46 necessarily means negatively affecting the battery health of the vehicle battery. As such, there is a tradeoff between variables 46 and 48. In other words, if variable 46 is weighed more heavily such that the user selects a value on line 44 that is closer to variable 48 than variable 46, maximizing VGI revenue will be prioritized higher than ensuring a good battery health for the vehicle. In contrast, if variable 46 is weighed more heavily, i.e., the user selects a value on line 44 that is closer to variable 46 than variable 48, ensuring a good battery health for the vehicle will be prioritized higher than maximizing VGI revenue generated by discharging the vehicle.

As shown in FIG. 3a, the GUI 32 displays a default value 50 for the Battery Barrier selection. The default value 50 is a value determined or predicted by a model trained using machine learning. For example, the model can be trained based on historical data for the user and/or vehicle, such as the number of charging cycles in a predetermined time period, the type of charging (i.e., fast charging, level 2 charging, wall charging), the start and end states of charge, the start and end times for charging, statistics regarding the odometer change in a predetermined time, and historical driving trip statistics (i.e., average speeds, battery temperatures, trip durations, trip idling times, and regenerative braking).

In particular, the default value can be the value of battery barrier which, given the accessibility setting and the historical data regarding the user and/or vehicle, maximizes the predicted VGI revenue while keeping the state of health of the battery at the lookahead time above 80%. However, if it is impossible to keep the state of health of the battery at the lookahead time above 80% under the circumstances, the default value can be set to the highest battery barrier value (optionally with a message communicated to the user on why that is the case).

The user can then decide whether to increase or decrease the Battery Barrier preference from the default value 50. The final user selection is shown in FIG. 3a as the second user input 52.

Based on the first user input 42 and the second user input 52, a VGI revenue 54 of $22.17 per month is estimated and displayed by the GUI 32. The VGI revenue 54 can be estimated in any suitable manner. For example, the VGI revenue can be estimated by using Pareto front simulations for the first user input 42, in which there is a tradeoff between charge insufficiency and VGI revenue, and the second user input 52, in which there is a tradeoff between VGI revenue and battery health.

FIG. 3b shows a second user terminal 60 showing first and second user inputs for accessibility and battery barrier according to the third embodiment. In particular, as with the first user terminal 30, the second user terminal 60 allows the user to customize the VGI revenue generated by the vehicle to ensure desired levels of accessibility and battery health.

The second user terminal 60 is a cellular phone that includes a GUI 62. However, it should be understood that the second user terminal 60 can be any suitable personal electronic device, such as a laptop or desktop computer, which allows a user to select values based on information displayed on the GUI. The second user terminal 60 can be located inside the vehicle connected to the VGI and/or remotely operated by a user of the vehicle.

In particular, the GUI 62 displays VGI preferences including Accessibility and Battery Barrier to a user of the vehicle connected to the VGI. For the Accessibility preference, the GUI 62 displays a line 64 between two variables—driver flexibility for using the car 66 and VGI revenue $$ 68. The line 64 represents a scale allowing the user to choose the relative importance between the two variables 66 and 68. Variable 66 represents the user's flexibility in being able to use the vehicle in the VGI. For example, variable 66 represents the importance of ensuring that the vehicle has a sufficient state of charge at any given time such that if the vehicle departs the VGI at an earlier than expected time, the state of charge will be high enough that the user can still use the vehicle as desired.

Maximizing VGI revenue 68 necessarily means negatively affecting the state of charge for the vehicle battery at a given time, thereby reducing the user's flexibility in using the vehicle. As such, there is a tradeoff between variables 66 and 68. In other words, if variable 68 is weighed more heavily such that the user selects a value on line 64 that is closer to variable 68 than variable 66, maximizing VGI revenue will be prioritized higher than ensuring a sufficient state of charge for the vehicle. In contrast, if variable 66 is weighed more heavily, i.e., the user selects a value on line 64 that is closer to variable 66 than variable 68, ensuring a sufficient state of charge for the vehicle at a given time will be prioritized higher than maximizing VGI revenue generated by discharging the vehicle.

As shown in FIG. 3b, the GUI 62 displays a default value 70 for the Accessibility selection. The default value 70 is a value determined or predicted by a model trained using machine learning. For example, the model can be trained based on historical data for the user and/or vehicle, such as plug-in times for the vehicle at the VGI, arrival state of charge and departure state of charge for the vehicle and/or user.

The user can then decide whether to increase or decrease the Accessibility preference from the default value 70. The final user selection is shown in FIG. 3b as the first user input 72. Unlike in FIG. 3a, the first user input 72 is lower than the default value 70 (i.e., weighed more heavily toward ensuring user flexibility rather than maximizing VGI revenue).

For the Battery Barrier preference, the GUI 62 displays a line 74 between two variables—VGI revenue 76 and battery health 78. The line 74 represents a scale allowing the user to choose the relative importance between the two variables 76 and 78. Variable 78 represents the importance of ensuring good battery health for the vehicle. For example, variable 78 represents the importance of ensuring that the vehicle is not charged or discharged in a way that negatively impacts battery health.

Maximizing VGI revenue 76 necessarily means negatively affecting the battery health of the vehicle battery. As such, there is a tradeoff between variables 76 and 78. In other words, if variable 76 is weighed more heavily such that the user selects a value on line 74 that is closer to variable 78 than variable 76, maximizing VGI revenue will be prioritized higher than ensuring a good battery health for the vehicle. In contrast, if variable 76 is weighed more heavily, i.e., the user selects a value on line 74 that is closer to variable 76 than variable 78, ensuring a good battery health for the vehicle will be prioritized higher than maximizing VGI revenue generated by discharging the vehicle.

As shown in FIG. 3b, the GUI 62 displays a default value 80 for the Battery Barrier selection. The default value 80 is a value determined or predicted by a model trained using machine learning. For example, the model can be trained based on historical data for the user and/or vehicle, such as the number of charging cycles in a predetermined time period, the type of charging (i.e., fast charging, level 2 charging, wall charging), the start and end states of charge, the start and end times for charging, statistics regarding the odometer change in a predetermined time, and historical driving trip statistics (i.e., average speeds, battery temperatures, trip durations, trip idling times, and regenerative braking).

In particular, the default value can be the value of battery barrier which, given the accessibility setting and the historical data regarding the user and/or vehicle, maximizes the predicted VGI revenue while keeping the state of health of the battery at the lookahead time above 80%. However, if it is impossible to keep the state of health of the battery at the lookahead time above 80% under the circumstances, the default value can be set to the highest battery barrier value (optionally with a message communicated to the user on why that is the case).

The user can then decide whether to increase or decrease the Battery Barrier preference from the default value 80. The final user selection is shown in FIG. 3b as the second user input 82. Although the second user input 82 is higher than the default value 80, the second user input 82 is still weighed more heavily toward maximizing VGI than ensuring good battery health. The second user input 82 for the second user terminal 60 is the same or substantially similar to the second user input 52 for the first user terminal 30.

Based on the first user input 72 and the second user input 82, a VGI revenue 84 of $15.82 per month is estimated and displayed by the GUI 62. The VGI revenue 84 can be estimated in any suitable manner. For example, the VGI revenue can be estimated by using Pareto front simulations for the first user input 72, in which there is a tradeoff between charge insufficiency and VGI revenue, and the second user input 82, in which there is a tradeoff between VGI revenue and battery health. The VGI revenue 84 for the second user terminal 60 is lower than the VGI revenue 54 for the first user terminal 30. This is because in the second user terminal 60, the first user input value 72 is weighed more heavily toward ensuring sufficient user flexibility than the first user input value 42 for the first user terminal 30.

FIG. 3c is a chart 90 showing charge profiles over time for the vehicle in the VGI based on the first and second user inputs from the first and second user terminals 30, 60 according to the third embodiment. In particular, chart 90 shows a first charge profile 92 for the vehicle based on the first user input 42 and the second user input 52 from the first user terminal 30, with an estimated VGI revenue of $22.17 per month. Chart 90 also shows a second charge profile 94 for the vehicle based on the first user input 72 and the second user input 82 from the second user terminal 60, with an estimated VGI revenue of $15.82 per month. Chart 90 also shows a required state of charge 96 at departure for the vehicle and a plug in time 98 for the vehicle.

As shown in FIG. 3c, in charge profile 94, the vehicle state of charge never gets as low as it does in charge profile 92. In other words, in charge profile 94, the vehicle is not discharged as much as in charge profile 92. This is because the first user input 72 used to determine charge profile 94 is weighed more heavily toward ensuring sufficient user flexibility than the first user input value 42 used to determine charge profile 92. As such, charge profile 94 is associated with a lower estimated VGI revenue than charge profile 92.

FIG. 3c also shows an area 100 representing the VGI revenue lost for charge profile 94 relative to charge profile 92. This lost revenue is a result of prioritizing user flexibility, or maintaining a sufficient state of charge at a given time, over maximizing VGI revenue to a greater degree for charge profile 94 than for charge profile 92. However, as shown in FIG. 3c, if the user departs at an unexpected plug out time 102, the state of charge for charge profile 94 is still close to the required state of charge, whereas it is significantly lower for charge profile 92.

As such, FIG. 3c demonstrates the tradeoff between lost VGI revenue and user flexibility when there is unpredictable or uncertain user behavior, such as an unexpected departure time. Although in the case of charge profile 92 VGI revenue is maximized, the user has less flexibility in plugging out at unexpected/earlier times, because the state of charge will be too far below the required departure state of charge. For users whose departure times rarely vary, it may therefore be beneficial to prioritize maximizing VGI revenue. However, for users who require more flexibility in things like departure times, it may be better to prioritize user flexibility despite losing some VGI revenue.

FIG. 4a is a first user terminal 130 showing first and second user inputs for accessibility and battery barrier according to a fourth embodiment. In particular, the first user terminal 130 allows a user with a vehicle in a VGI to customize the VGI revenue generated by the vehicle to ensure the desired levels of accessibility and battery health.

As shown in FIG. 4a, the first user terminal 130 is a cellular phone that includes a GUI 132. However, it should be understood that the first user terminal 130 can be any suitable personal electronic device, such as a laptop or desktop computer, which allows a user to select values based on information displayed on the GUI. The user terminal 130 can be located inside a vehicle that is connected to a VGI and/or remotely operated by a user of the vehicle.

In particular, the GUI 132 displays VGI preferences including Accessibility and Battery Barrier to a user of the vehicle connected to the VGI. For the Accessibility preference, the GUI 132 displays a line 134 between two variables—driver flexibility for using the car 136 and VGI revenue $$ 138. The line 134 represents a scale allowing the user to choose the relative importance between the two variables 136 and 138. Variable 136 represents the user's flexibility in being able to use the vehicle in the VGI. For example, variable 136 represents the importance of ensuring that the vehicle has a sufficient state of charge at any given time such that if the vehicle departs the VGI at an earlier than expected time, the state of charge will be high enough that the user can still use the vehicle as desired.

Maximizing VGI revenue 138 necessarily means negatively affecting the state of charge for the vehicle battery at a given time, thereby reducing the user's flexibility in using the vehicle. As such, there is a tradeoff between variables 136 and 138 such that the user must choose a value reflecting the prioritization of one variable over the other.

As shown in FIG. 4a, the GUI 132 displays a default value 140 for the Accessibility selection. The default value 140 is a value determined or predicted by a model trained using machine learning. For example, the model can be trained based on historical data for the user and/or vehicle, such as plug-in times for the vehicle at the VGI, arrival state of charge and departure state of charge for the vehicle and/or user.

The user can then decide whether to increase or decrease the Accessibility preference from the default value 140. The final user selection is shown in FIG. 4a as the first user input 142.

For the Battery Barrier preference, the GUI 132 displays a line 144 between two variables—VGI revenue 146 and battery health 148. The line 144 represents a scale allowing the user to choose the relative importance between the two variables 146 and 148. Variable 148 represents the importance of ensuring good battery health for the vehicle. For example, variable 148 represents the importance of ensuring that the vehicle is not charged or discharged in a way that negatively impacts battery health.

Maximizing VGI revenue 146 necessarily means negatively affecting the battery health of the vehicle battery. As such, there is a tradeoff between variables 146 and 148. In other words, if variable 146 is weighed more heavily such that the user selects a value on line 144 that is closer to variable 148 than variable 146, maximizing VGI revenue will be prioritized higher than ensuring a good battery health for the vehicle. In contrast, if variable 146 is weighed more heavily, i.e., the user selects a value on line 144 that is closer to variable 146 than variable 148, ensuring a good battery health for the vehicle will be prioritized higher than maximizing VGI revenue generated by discharging the vehicle.

As shown in FIG. 4a, the GUI 132 displays a default value 150 for the Battery Barrier selection. The default value 150 is a value determined or predicted by a model trained using machine learning. For example, the model can be trained based on historical data for the user and/or vehicle, such as the number of charging cycles in a predetermined time period, the type of charging (i.e., fast charging, level 2 charging, wall charging), the start and end states of charge, the start and end times for charging, statistics regarding the odometer change in a predetermined time, and historical driving trip statistics (i.e., average speeds, battery temperatures, trip durations, trip idling times, and regenerative braking).

In particular, the default value can be the value of battery barrier which, given the accessibility setting and the historical data regarding the user and/or vehicle, maximizes the predicted VGI revenue while keeping the state of health of the battery at the lookahead time above 80%. However, if it is impossible to keep the state of health of the battery at the lookahead time above 80% under the circumstances, the default value can be set to the highest battery barrier value (optionally with a message communicated to the user on why that is the case).

The user can then decide whether to increase or decrease the Battery Barrier preference from the default value 150. The final user selection is shown in FIG. 4a as the second user input 152.

Based on the first user input 142 and the second user input 152, a VGI revenue 154 of $9.71 per month is estimated and displayed by the GUI 132. The VGI revenue 154 can be estimated in any suitable manner. For example, the VGI revenue can be estimated by using Pareto front simulations for the first user input 142, in which there is a tradeoff between charge insufficiency and VGI revenue, and the second user input 152, in which there is a tradeoff between VGI revenue and battery health.

FIG. 4b is a chart 160 showing charge profiles over time for the vehicle in the VGI based on the first and second user inputs and default values from the first user terminal 130 according to the third embodiment. In particular, chart 160 shows a first charge profile 162 for the vehicle based on the default values 140 and 150 for the first and second user inputs, respectively. Chart 160 also shows a second charge profile 164 for the vehicle based on the first user input 142 and the second user input 152 from the first user terminal 130, with an estimated VGI revenue of $9.71 per month. Chart 160 also shows a required state of charge 166 at departure for the vehicle and a plug in time 168 for the vehicle.

As shown in FIG. 4b, in charge profile 162, the vehicle state of charge never gets as low as it does in charge profile 164. In other words, in charge profile 162, the vehicle is not discharged as much as in charge profile 164. This is because the second user input 152 used to determine charge profile 162 is weighed much more heavily toward ensuring sufficient battery health than the second default value 150 used to determine charge profile 164. As such, charge profile 162 is associated with a lower estimated VGI revenue than charge profile 164.

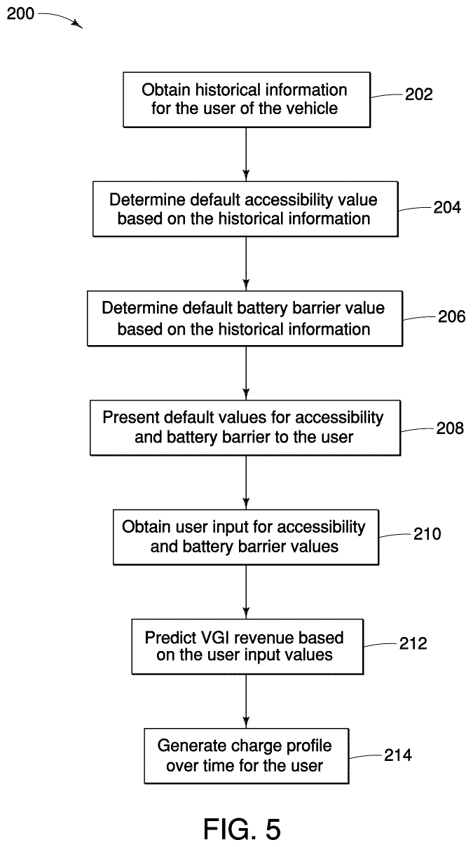

FIG. 5 shows a process 200 of managing the charging and discharging of an individual vehicle by generating a charge profile for a vehicle in a VGI in accordance with a fifth embodiment. The vehicle is an electrical vehicle connected to a power demand source that is further connected to a grid. The vehicle can be one of a plurality of electric vehicles connected to the power demand source. The power demand source can be any suitable demand source for a VGI, such as a residential or commercial building, an industrial facility, a transportation system, an agricultural system, or another power demand source connected to the grid. The process 200 can be implemented by a processor such as a CPU or an MPU, and the processor can be included in an electronic controller.

In Step 202, the processor obtains historical information for the vehicle and/or the specific user of the vehicle. The historical information includes historical information for the user and/or vehicle, such as plug-in times and departure times for the vehicle at the VGI, arrival state of charge and departure state of charge for the vehicle and/or user, and information regarding the vehicle battery. The historical information can also include information regarding the demand source, such as usage patterns for the demand source.

The processor then determines a default accessibility value in Step 204 based on the historical information obtained in Step 202. For example, the default accessibility value is determined or predicted by a model trained using machine learning. The model can be trained based on the historical information for the user and/or vehicle, such as plug-in times for the vehicle at the VGI, arrival state of charge and departure state of charge for the vehicle and/or user, and past usage information regarding the vehicle and/or the user.

The default accessibility value can be determined by using a Pareto front to optimize the tradeoff between VGI revenue and ensuring that the vehicle has a desired end state of charge at the end of a charging session. The model can also be trained based on the number of past settings changes and the mean/variance of the past settings.

In Step 206, the processor determines a default battery barrier value based on the historical information obtained in Step 202. The default battery barrier value can be determined or predicted by a model trained using machine learning. For example, the model can be trained based on the historical information for the user and/or vehicle, such as the number of charging cycles in a predetermined time period, the type of charging (i.e., fast charging, level 2 charging, wall charging), the start and end states of charge, the start and end times for charging, statistics regarding the odometer change in a predetermined time, and historical driving trip statistics (i.e., average speeds, battery temperatures, trip durations, trip idling times, and regenerative braking).

In particular, the default value can be the value of battery barrier which, given the accessibility setting and the historical data regarding the user and/or vehicle, maximizes the predicted VGI revenue while keeping the state of health of the battery at the lookahead time above 80%. However, if the state of health of the battery at the lookahead time cannot be kept above 80%, the default value can be set to the highest battery barrier value (optionally with a message communicated to the user on why that is the case).

In Step 208, the default accessibility value and the default battery barrier value are presented to the user. For example, the default accessibility and battery barrier values can be sent by the processor to a user terminal having a GUI or another display, and the default values can be displayed for a user of the user terminal.

The processor then obtains user inputs for the accessibility and battery barrier values in Step 210. In particular, the processor obtains a first user input for the accessibility value and a second user input for the battery barrier value. The first user input is a value representing prioritization of ensuring a sufficient state of charge for the vehicle battery at a given time over maximizing revenue generated by discharging the battery to generate power for the power grid. The first user input can be the same as the default accessibility value, or the user can select a higher or lower value for the first user input. A higher value represents greater prioritization of user flexibility by ensuring a sufficient state of charge for the vehicle battery.

The second user input is a value representing prioritization of ensuring a battery health for the battery over maximizing revenue generated by discharging the battery to generate power for the power grid. The second user input can be the same as the default battery barrier value, or the user can select a higher or lower value for the second user input. A higher value represents greater prioritization of battery health when considering how to manage the charging and discharging of the vehicle battery.

In Step 212, the processor predicts the VGI revenue based on the first user input and the second user input values. The VGI revenue can be estimated in any suitable manner. For example, the VGI revenue can be estimated by using Pareto front simulations for the first user input, in which there is a tradeoff between charge insufficiency and VGI revenue, and the second user input, in which there is a tradeoff between VGI revenue and battery health. The VGI revenue can optionally be displayed to the user of the vehicle. For example, the processor can send the predicted VGI revenue to a user terminal having a GUI or another display, and the predicted VGI revenue can be displayed for a user of the user terminal.

The processor then generates a charge profile for the vehicle in Step 214 based on the first user input and the second user input. The charge profile indicates the state of charge of the vehicle over time. The amount of discharging and charging of the vehicle, as well as the timing of the charging and discharging of the vehicle, are determined by weighing the values of the first user input and the second user input and considering how much to prioritize ensuring a sufficient state of charge for the vehicle battery and ensuring a good battery health against maximizing VGI revenue.

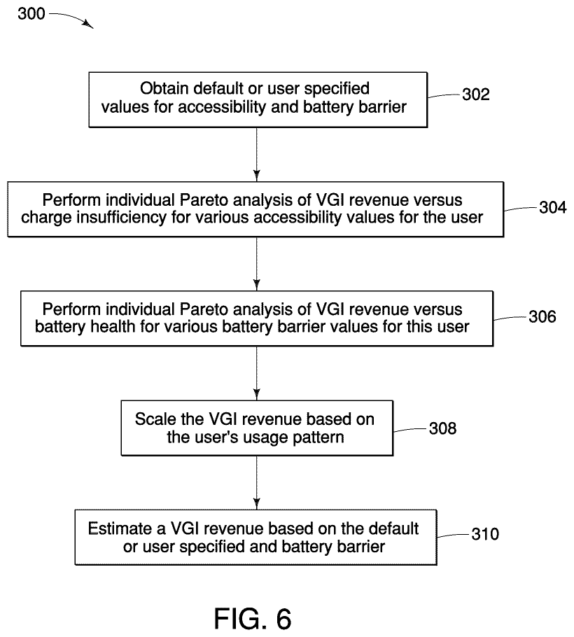

FIG. 6 shows a process 300 of estimating VGI revenue for a vehicle in a vehicle grid integration system according to a sixth embodiment. The vehicle is an electrical vehicle connected to a power demand source that is further connected to a grid. The vehicle can be one of a plurality of electric vehicles connected to the power demand source. The power demand source can be any suitable demand source for a VGI, such as a residential or commercial building, an industrial facility, a transportation system, an agricultural system, or another power demand source connected to the grid. The process 300 can be implemented by a processor such as a CPU or an MPU, and the processor can be included in an electronic controller.

In Step 302, the processor obtains default or user input values for accessibility and battery barrier. In particular, the processor determines a default accessibility value based on historical information for the vehicle and/or the specific user of the vehicle. The historical information includes historical information for the user and/or vehicle, such as plug-in times and departure times for the vehicle at the VGI, arrival state of charge and departure state of charge for the vehicle and/or user, and information regarding the vehicle battery. The historical information can also include information regarding the demand source, such as usage patterns for the demand source.

The default accessibility value can be determined or predicted by a model trained using machine learning. The model can be trained based on the historical information for the user and/or vehicle, such as plug-in times for the vehicle at the VGI, arrival state of charge and departure state of charge for the vehicle and/or user, and past usage information regarding the vehicle and/or the user.

The default accessibility value can be determined by using a Pareto front to optimize the tradeoff between VGI revenue and ensuring that the vehicle has a desired end state of charge at the end of a charging session. The model can also be trained based on the number of past settings changes and the mean/variance of the past settings.

The processor also determines a default battery barrier value based on the historical information. The default battery barrier value can be determined or predicted by a model trained using machine learning. For example, the model can be trained based on the historical information for the user and/or vehicle, such as the number of charging cycles in a predetermined time period, the type of charging (i.e., fast charging, level 2 charging, wall charging), the start and end states of charge, the start and end times for charging, statistics regarding the odometer change in a predetermined time, and historical driving trip statistics (i.e., average speeds, battery temperatures, trip durations, trip idling times, and regenerative braking).

In particular, the default value can be the value of battery barrier which, given the accessibility setting and the historical data regarding the user and/or vehicle, maximizes the predicted VGI revenue while keeping the state of health of the battery at the lookahead time above 80%. However, if the state of health of the battery at the lookahead time cannot be kept above 80%, the default value can be set to the highest battery barrier value (optionally with a message communicated to the user on why that is the case).

The processor can also obtain a first user input for the accessibility value and a second user input for the battery barrier value. The first user input is a value representing prioritization of ensuring a sufficient state of charge for the vehicle battery at a given time over maximizing revenue generated by discharging the battery. The first user input can be the same as the default accessibility value, or the user can select a higher or lower value for the first user input. A higher value represents greater prioritization of user flexibility when charging and discharging the vehicle battery.

The second user input is a value representing prioritization of ensuring a battery health for the battery over maximizing revenue generated by discharging the battery. The second user input can be the same as the default battery barrier value, or the user can select a higher or lower value for the second user input. A higher value represents greater prioritization of battery health when charging and discharging the vehicle battery.

In Step 304, the processor performs an individual Pareto analysis of VGI revenue versus charge insufficiency for various accessibility values for the user. Maximizing VGI revenue necessarily means decreasing the state of charge for the vehicle battery at a given time, thereby reducing the user's accessibility or flexibility in using the vehicle. As such, there is a tradeoff between charge insufficiency and VGI revenue. The Pareto analysis can use a tradeoff parameter value, for example a number from 0 to 1.0 representing the tradeoff between charge insufficiency and VGI revenue, for a Parent front simulation calculated using historical data regarding the vehicle, the user and/or the demand source.

The processor also performs an individual Pareto analysis of VGI revenue versus battery health for various battery barrier values for the user in Step 306. As with accessibility, maximizing VGI revenue necessarily means negatively affecting battery health. Thus, there is a tradeoff between battery health and VGI revenue. The Pareto analysis can use a tradeoff parameter value, for example a number from 0 to 1.0 representing the tradeoff between battery health and VGI revenue, for a Parent front simulation calculated using historical data regarding the vehicle, the user and/or the demand source.

In Step 308, the VGI revenue is then scaled based on the user's usage pattern and price data. For example, if the user averages 6 VGI sessions per month, the arrival state of charge for that user is on average 40%, and the desired departure state of charge for the user is 85%. Given the settings for the user, any one of the session frequency, session statistics such as arrival and departure times and corresponding states of charge, and data regarding the charging price can be used as inputs to a machine learning model. Historical samples can be calculated by calculating charge schedules with varied user settings and inputs. From those schedules, actual calculated values of revenue from each session can be used to complete the (input, output) samples used to train the model.

In Step 310, the processor estimates or predicts the VGI revenue based on the first user input and the second user input values, which can be the same as the default values. The VGI revenue is estimated using the Pareto front simulations generated in Steps 304 and 306. The VGI revenue can optionally be displayed to the user of the vehicle. For example, the processor can send the predicted VGI revenue to a user terminal having a GUI or another display, and the predicted VGI revenue can be displayed for a user of the user terminal.

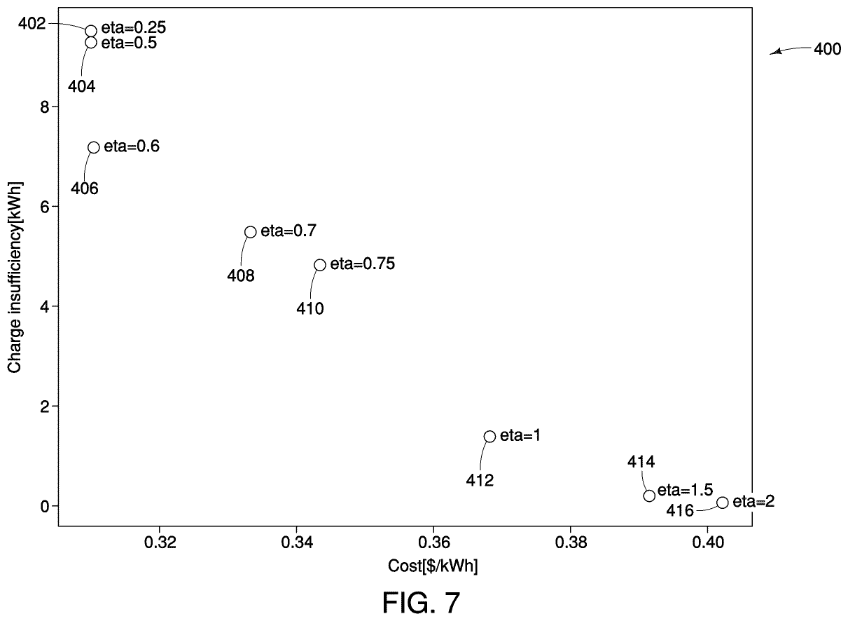

FIG. 7 is a Pareto front chart 400 showing the tradeoff between charging cost and charging insufficiency for a vehicle in a vehicle grid integration system according to a seventh embodiment. The vehicle grid integration system includes a demand source, and the vehicle is connected to the demand source. The vehicle is an electric vehicle. The demand source can be any suitable demand source connected to the power grid, such as a residential or commercial building, an industrial facility, a transportation system, an agricultural system, or another power demand source connected to the grid.

As shown in FIG. 7, the charge insufficiency is shown as a value in kWh, and the charging cost is shown as a value in $/kWh. Reference numbers 402-416 represent various locations on the Pareto front chart for corresponding accessibility tradeoff parameter values (“eta”). For example, point 402 shows the charge insufficiency and charging cost when the eta is 0.25, and point 404 represents the location on the Pareto chart when the eta is 0.50. As shown in FIG. 7, the charge insufficiency and cost are nearly identical for eta values of 0.25 and 0.50.

However, when the eta is changed to 0.6, as shown by point 406, the charge insufficiency is lowered while maintaining a similar charging cost. FIG. 7 also shows that when the eta is further increased to 0.7, as shown by point 408, the charge insufficiency is lowered but the charging cost is also increased.

Point 410 shows that there is only a small difference in both charge insufficiency and charging cost when the eta is increased from 0.7 to 0.75. However, the charge insufficiency is significantly decreased, along with the charging cost, when the eta is further increased to 1.

Point 414 represents the location on the Pareto chart 400 for an eta of 1.5, and point 416 represents the location on the Pareto chart 400 for an eta of 2. As shown by points 414 and 416, when the eta is further increased from 1 to 1.5 or 2, the charge insufficiency is decreased slightly, but the charging cost is simultaneously increased.

The Pareto front chart 400 can be used to estimate the VGI revenue based on the first user input regarding accessibility as explained above.

By managing the charging and discharging of an individual EV based on a first user input representing prioritization of accessibility over maximizing VGI revenue, the VGI is able to account for uncertain user behavior such as departing the VGI earlier than expected by allowing the user to prioritize user flexibility or accessibility to a larger degree. Furthermore, by allowing the user to select the prioritization level or value for both accessibility and battery health, the VGI can allow the user more control in ensuring that the VGI revenue is not maximized at the expense of battery health or accessibility.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, should also be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

1. A system for managing charging and discharging of a vehicle interfacing with a demand source and a power grid, the system comprising:
a charging station configured to at least one of: supply power to and draw power from a battery of the vehicle at specified times;
a user terminal including a display; and
a controller configured to control at least one of charging and discharging of the battery by the charging station based on at least one of: a first user input and a second user input,
the first user input being a first value representing prioritization of ensuring a sufficient state of charge for the battery at a given time over maximizing revenue generated by discharging the battery to generate power for the power grid,
the second user input being a second value representing prioritization of ensuring a battery health for the battery over maximizing revenue generated by discharging the battery to generate power for the power grid,
the user terminal being configured to receive the at least one of: the first user input and the second user input from a user of the vehicle, and
the display being configured to display at least one of:
a first variable representing the ensuring the sufficient state of charge for the battery at the given time and a second variable representing the maximizing the revenue generated by discharging the battery, and
a third variable representing the ensuring the battery health for the battery and a fourth variable representing the maximizing the revenue generated by discharging the battery.

2. The system according to claim 1, wherein
the controller is configured to generate a charging profile for the battery based on the at least one of: the first user input and the second user input.

3. The system according to claim 2, wherein
the charging profile for the battery is further based on a required state of charge for the battery at departure and an arrival time of the vehicle at the charging station.

4. The system according to claim 1, wherein
the controller is configured to determine at least one of: a first default value for the first user input and a second default value for the second user input based on historical information regarding at least one of the vehicle and a user of the vehicle.

5. The system according to claim 4, wherein
the historical information includes historical values for at least one of: an arrival time of the vehicle at the charging station, an arrival state of charge of the vehicle upon arrival at the charging station, and a departure state of charge of the vehicle upon departure from the charging station.

6. The system according to claim wherein
the user terminal is configured to communicate the at least one of the first user input and the second user input to the controller, and
the display is configured to display at least one of the first default value and the second default value to the user.

7. The system according to claim 1, wherein
the controller is configured to determine an expected revenue for discharging the battery to generate power for the power grid.

8. The system according to claim 7,
wherein the controller is configured to communicate the expected revenue to the user terminal, and the display is configured to display the expected revenue to the user of the vehicle.

9. The system according to claim 7, wherein
the expected revenue is determined using a machine learning model.

10. The system according to claim 1, wherein
the controller is further configured to control the charging and discharging of the battery based on a predicted departure time for the vehicle from the charging station and a predicted health effect on the battery.

11. The system according to claim 10, wherein
the predicted departure time for the vehicle and the predicted health effect on the battery are determined using a machine learning model.

12. The system according to claim 1, wherein
the vehicle is one of a plurality of vehicles each connected to the power grid, and
the controller is configured to control the charging and discharging of each of the plurality of vehicles based on user inputs for each vehicle regarding at least one of:
prioritization of ensuring a sufficient state of charge for a battery of the vehicle at a given time over maximizing revenue generated by discharging the battery to generate power for the power grid, and prioritization of ensuring a battery health for the battery over maximizing revenue generated by discharging the battery to generate power for the power grid.

13. The system according to claim 12, wherein
the controller is configured to assign each of the plurality of vehicles to a unidirectional charging station or a bidirectional charging station based on the user inputs for each vehicle.

14. A method of managing charging and discharging of a vehicle interfacing with a demand source and a power grid, the method comprising:
providing a controller configured to control charging and discharging of a battery of the vehicle at specified times, and a user terminal including a display,
controlling the charging and discharging of the battery using the controller based on at least one of: a first user input and a second user input, and
displaying to a user of the vehicle at least one of:
a first variable representing ensuring the sufficient state of charge for the battery at the given time and a second variable representing maximizing the revenue generated by discharging the battery, and
a third variable representing ensuring the battery health for the battery and a fourth variable representing maximizing the revenue generated by discharging the battery,
the first user input being a first value representing prioritization of the first variable over the second variable,
the second user input being a second value representing prioritization of the third variable over the fourth variable.

15. The method according to claim 14, further comprising
providing at least one charging station configured to at least one of: supply power to and draw power from the vehicle at specified times.

16. The method according to claim 14, wherein
the controller is a central processing unit or a remote server in communication with the vehicle.

17. The method according to claim 12, wherein
the controller is configured to determine at least one of: a first default value for the first user input and a second default value for the second user input based on historical information regarding at least one of the vehicle and a user of the vehicle.

18. The method according to claim 17, further comprising
displaying at least one of the first default value and the second default value to the user of the vehicle.

19. The method according to claim 14, wherein
the controller is configured to determine an expected revenue for discharging the battery to generate power for the power grid.

20. The method according to claim 19, wherein
the expected revenue is determined using a machine learning model.
